(19) United States
(12) Patent Application Publication
(10) Pub. No.: US 2026/0073001 A1
(43) Pub. Date: Mar. 12, 2026

(54) COMPUTER-IMPLEMENTED SYSTEM AND METHOD FOR PROVIDING WEBSITE NAVIGATION RECOMMENDATIONS

(71) Applicant: Xerox Corporation, Webster, NY (US)

(72) Inventors: Kristian Lyngbaek, Palo Alto, CA (US); Lester D. Nelson, Santa Clara, CA (US); Eric A. Bier, Palo Alto, CA (US); Margaret H. Szymanski, Santa Clara, CA (US)

(21) Appl. No.: 19/392,801

(22) Filed: Nov. 18, 2025

Related U.S. Application Data
(63) Continuation of application No. 18/209,269, filed on Jun. 13, 2023, now Pat. No. 12,499,169.
Application No. 18/209,269 is a continuation of application No. 13/673,917, filed on Nov. 9, 2012, now abandoned.

(51) Int. Cl. G06F 16/955; G06F 16/954

(52) U.S. Cl. CPC G06F 16/9566; G06F 16/954

(57) ABSTRACT

A system and method for providing Website navigation recommendations is provided. A Web page of interest is identified as a destination Web page. A domain of Web pages related to the destination Web page is determined. Information is extracted from each Web page in the domain and a recommendation comprising instructions for navigating to the destination Web page is generated based on the extracted information.

### CROSS-REFERENCE TO RELATED APPLICATION

This patent application is a continuation of U.S. patent application Ser. No. 13/673,917 filed on Nov. 9, 2012, the contents of which are incorporated herein in their entirety by reference.

### FIELD

This application relates in general to navigating Websites, and in particular, to a computer-implemented system and method for providing Website navigation recommendations.

### BACKGROUND

The use of computers is widespread and as the Internet becomes the primary source for users to obtain information, efficiently navigating to a Web page with desired information becomes extremely important so that users can quickly and easily obtain the information. However, based on a large amount of available data, the desired information can be difficult to locate due to the structure and set up of a Web site, unclear page links, time to reach the desired information and long paths to reach the desired information, as well as other barriers. Thus, users often require assistance to reach the desired information.

Directing a user to the information can be a difficult task, especially using limited interpersonal communication types, such as the telephone or other device through which voice is provided. Conventionally, a user places a call to an agent at a call center in an attempt to locate the information. The agent can verbally provide instructions on how to reach the desired information. However, the verbal instructions can be difficult to understand and directing the user to the information via the verbal instructions can be time consuming as the agent must often repeat or reword the instructions. Further, each agent subjectively provides the instructions and different instructions can be provided by different agents, resulting in inconsistent instructions. As well, due to the subjective, inconsistent, and sometimes confusing instructions, the users are frequently unable to access the same information at a later time, despite receiving the instructions from the agent.

Thus, a system and method for providing efficient and easy-to-understand instructions to locating requested information is needed. Preferably the user will learn about the structure of the Website from the provided instructions so as to be able to access the same or similar information without further assistance.

### SUMMARY

Often times, locating a desired Web page can be difficult due to large amounts of information available on the Web or a complex structure of a domain to which the Web page belongs. Verbally conveying instructions to a user for reaching the desired Web page can be frustrating and unsuccessful. A recommendation for efficiently reaching the destination Web page can be provided based on data extracted from the domain. The recommendation can include providing short link recommendations, search queries, or a path from a source Web page to the destination Web page.

An embodiment provides a system and method for providing Website navigation recommendations is provided. A Web page of interest is identified as a destination Web page. A domain of Web pages related to the destination Web page is determined. Information is extracted from each Web page in the domain and a recommendation comprising instructions for navigating to the destination Web page is generated based on the extracted information.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for providing Website navigation recommendations, in accordance with one embodiment.

FIG. 2 is a flow diagram showing a method for providing Website navigation recommendations, in accordance with one embodiment.

FIG. 3 is a flow diagram showing, by way of example, a process for determining a domain for a particular Web page.

FIG. 4 is a block diagram showing, by way of example, a process for obtaining information for use in generating an index for navigation assistance.

FIG. 5 is a flow diagram showing, by way of example, different types of recommendations for navigation assistance.

FIG. 6 is a flow diagram showing, by way of example, a process for generating a search term recommendation for navigation assistance.

FIG. 7 is a flow diagram showing, by way of example, a process for generating a path recommendation for navigation assistance.

FIG. 8 is a screenshot of a Web page displaying a script to an agent.

### DETAILED DESCRIPTION

Users frequently turn to the Internet to obtain desired information, including, inter alia, instructions or content and product information. However, navigating to a particular Web page with the desired information can be difficult. Further, providing instructions regarding navigating to the Web page can be time consuming and frustrating to the users requesting the information. For example, a user having trouble locating a particular Web page with the requested information places a call for assistance, such as to a call center associated with the requested information. An agent at the assistance center verbally attempts to provide instructions on how to reach the Web page over the telephone, but the user cannot understand the instructions so the agent repeats himself or provides an alternate explanation. Hopefully, the agent is able to direct the caller to the requested information, but if not, the agent must take further action to handle the call.

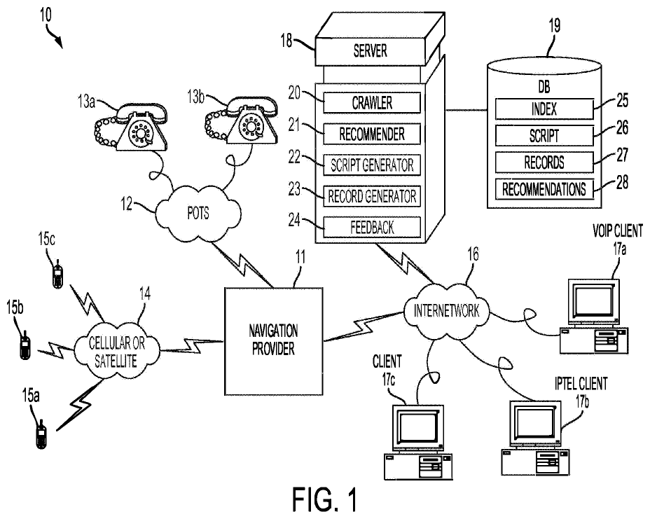

To efficiently direct the user to the Web page and provide the user with necessary tools to be able to return to the Web page, the agent can provide recommendations for navigation to the Web page, which are based on the content and structure of the Website with the requested information. Determining navigation recommendations requires a system involving analysis of a designated set of Web pages. FIG. 1 is a functional block diagram showing a system 10 for providing Website navigation recommendations, in accordance with one embodiment. A user can contact an assistance center 11 for help locating information on a particular Web page via conventional telephone handsets 13a-c through Plain Old Telephone Service (POTS) 12, portable handsets 15a-c through cellular and satellite telephone service 14, and VoIP clients 17 and Internet telephony clients 18, as well as other forms and combinations of telephony, message, and voice-based communications via an Internetwork 16. The assistance center 16 can include a call center, which is operated by a company to address information queries from consumers and provide product support. The assistance center can include agents that answer calls from the consumers and provide the requested information. Except as otherwise stated, as used herein, the terms “user” and “caller” are used interchangeably to refer to a caller to the assistance center 11, and the terms “agent” and “service provider” are used interchangeably to refer to an agent that provides navigation instructions to the caller.

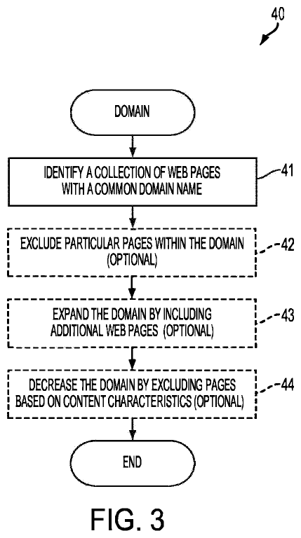

A call is received into the assistance center from a user. During the call, the user requests assistance regarding locating a particular Web page with desired information. The request is transmitted to a server 18 via the Internetwork 16 for processing and identifying the Web page as a destination Web page. Alternatively, the server 18 can be local to the assistance center. Initially, a domain is defined for the desired Web page. Alternatively, the domain can be predetermined. The domain includes a document set, such as a collection of Web pages on a Website or a collection of Websites, files, databases, or file management system related to the desired information. The domain can be generated by the user, agent, or automatically. Defining a domain is further described below with reference to FIG. 3.

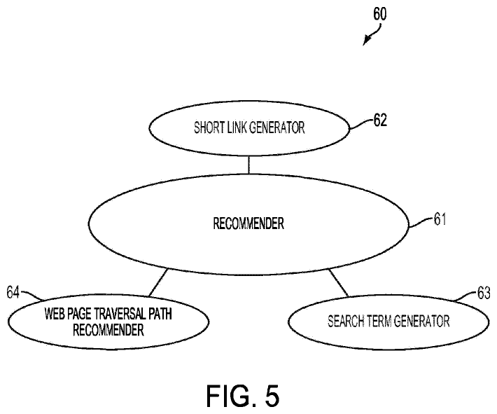

Once defined, a WebCrawler 20 navigates to and parses each Web page in the domain. Relevant information is extracted from the Web pages and stored in an index 25 that is maintained in a database 19 that is interconnected to the server 18. The WebCrawler 20 can navigate to each Web page in the domain by traversing links in each page or by generating a list of Uniform Resource Identifiers (URIs), which can include Uniform Resource Locators (URLs). Subsequently, a recommender 21 utilizes the information in the index to generate a recommendation 28 for navigating to the desired Web page. The recommendation can include navigations instructions and can be generated via a shortlink generator (not shown), a search term generator (not shown), or a Web page traversal path recommender (not shown). The recommendations can be stored in the database 19 for subsequent use. A short link generator creates and assigns a short link to the desired Web page, while the search term generator generates a search query for identifying the destination Web page. Meanwhile, the path recommender builds a path of links within the domain from a source Web page to the desired destination Web page. Generating a recommendation is further described below with reference to FIGS. 5-7.

The recommendation is then provided to the agent at the assistance center for relaying to the user. In one embodiment, a script 26 can be generated via a script generator 22 based on the recommendation so that the agent relays the navigation directions by reading the script 26 to the user. In a further embodiment, a script 26 previously generated and stored in the database can be provided to the agent for relaying to the user. The navigation instructions can also be provided via text, such as in an email, SMS text message, or via Instant Messenger. After the navigation instructions are provided and the user locates the desired Web page, a record generator 23 can document the call based on the call script 26, which is stored as a record 27 of the call in the database 19. Finally, a feedback module 24 can evaluate the recommendation 28 to determine whether refinement is necessary before providing the same recommendation to a further user. The evaluation can be based on metrics, such as repeatability, error rate, learnability, and number of clicks, as well as other metrics, which are described in detail below.

The handsets, computers, and server each include components conventionally found in general purpose programmable computing devices, such as a central processing unit, memory, input/output ports, network interfaces, and non-volatile storage, although other components are possible. Moreover, other information sources in lieu of or in addition to the servers, and other information consumers, in lieu of or in addition to the handsets and computers, are possible.

Additionally, the handsets, computers, and server can each include one or more modules for carrying out the embodiments disclosed herein. The modules can be implemented as a computer program or procedure written as source code in a conventional programming language and is presented for execution by the central processing unit as object or byte code or written as interpreted source code in a conventional interpreted programming language interpreted by a language interpreter itself executed by the central processing unit as object, byte, or interpreted code. Alternatively, the modules could also be implemented in hardware, either as integrated circuitry or burned into read-only memory components. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

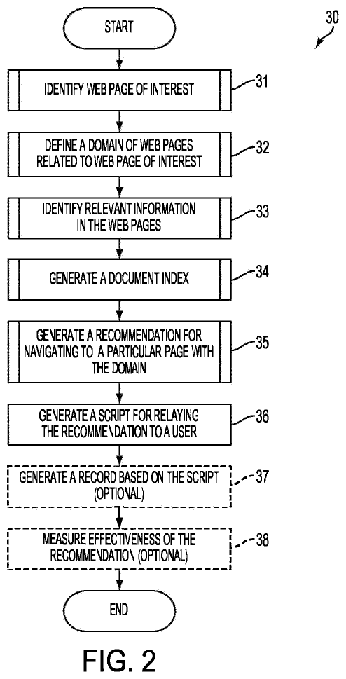

A recommendation for navigating to a destination Web page can efficiently direct users to desired information, while providing tools to the users to re-access the Web page at a later time. FIG. 2 is a flow diagram showing a method 30 for providing Website navigation recommendations, in accordance with one embodiment. A user conducts a search for desired information on a Website and is unable to locate the information. The user can then place a call to a assistance center and request instructions for navigating to the desired information from an agent at the assistance center. In one embodiment, the assistance center can own or manage the Website with the desired information. However, other relationships between the Website and assistance center are possible. Alternatively, the user can send the request for instructions via a text message, Instant Messaging, or email, as well as other forms of communication. In the following discussion, a call center is used as an example.

During the call interaction, the user identifies desired information or a Web page of interest (block 31). If desired information is provided, the Web page of interest can be determined automatically or by the agent. The Web page of interest is determined to be the destination Web page to which instructions are provided via a recommendation. Except as otherwise stated, as used herein, the terms “Web page of interest” and “destination Web page” are used interchangeably to refer to the Web page which includes information requested by a user and to which navigation instructions are provided.

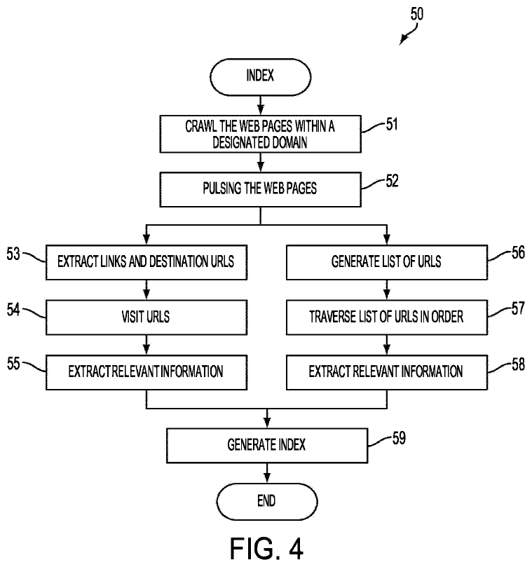

A domain of Web pages is defined for the Web page of interest (block 32). The domain includes Web pages related to the Web page of interest and defining the domain is further described below with reference to FIG. 3. Relevant information within the Web pages of the domain is identified (block 33) and extracted to generate a document index (block 34). The relevant information can include relationships between the domain pages, metadata of each of the pages, and content of the pages. Identifying the relevant information is further discussed below with reference to FIG. 4.

The index can be structured as a graph representation of the structure of the Web pages or a hash table where each Web page maps to a set of attributes. In the graph representation, the Web pages can be represented by nodes, while connections shared between the Web pages are represented by links. The hash table can include a list of the Web pages that are each mapped to a set of attributes. The attributes can include nouns and noun phrases, tokens, titles, URIs and links, as well as other attributes.

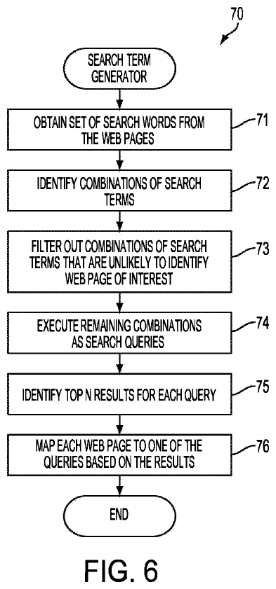

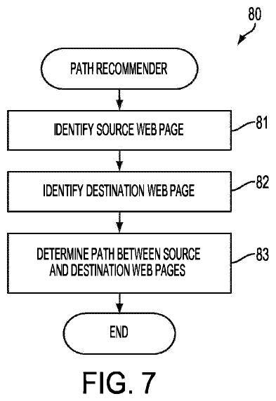

Based on the information in the index, a recommendation for navigating to the Web page of interest is generated (block 35). The type of structured index for use in generating a navigation recommendation is dependent upon the type of recommendation to be generated. For instance, a graph representation can be used to generate a path recommendation, while the hash table can be used to generate a query recommendation, as further discussed below with reference to FIGS. 6 and 7. Generating the recommendation is further discussed below with reference to FIGS. 5-7. A script of the recommendation can be generated (block 36) for relaying the recommended instructions to the user. Optionally, a record of the user interaction can be made based on the script (block 37). Further, the recommendation can be analyzed and refined if necessary (block 38).

A domain of Web pages is defined upon receiving a Web page of interest from a user. The Web pages of the domain can be related to the page of interest, such as by sharing a common domain name or linking to a page with the common domain name. Determining the domain is important since information within the domain is used to provide the navigation recommendations. If the defined domain is too small, there may not be enough information to generate a navigation path between a source page and the destination Web page. Alternatively, if the domain is too large, determining the navigation recommendation can take too long to process during the call without frustrating or angering the caller.

The domain can be determined automatically, by the user, by the agent, or as a combination. FIG. 3 is a flow diagram showing, by way of example, a process 40 for determining a domain for a destination Web page. A collection of Web pages related to the destination Web page is identified (block 41). The related pages can share a common domain name with the Web page of interest. For example, a user is looking for an insurance form to fill out on the California Health Care (“CHC”) Website. All the Web pages with the domain name californiahealthcare.com can be identified. Each of the Web pages is analyzed and can optionally be applied to exclusion rules (block 42). If the exclusion rule does not apply to the Web page, that page is included in the domain.

The exclusion rules can include a predetermined list of Web pages to exclude, including those Web pages having a particular URI within the domain or that include a particular terms in the URI. For instance, returning to the above example, Web pages with the URI, http://reports.californiahealthcare.com, can be excluded from the domain or Web pages having the term “banner” in the URI can be excluded. The remaining Web pages can then be defined as the domain.

The domain can optionally be refined to ensure that an adequate number of Web pages are included to generate a fast and accurate recommendation for navigation. For instance, the domain can be expanded or decreased by including additional Web pages (block 43) within a particular distance from a Web page within the domain or by excluding Web pages with particular content characteristics (block 44), respectively. Returning to the above example, the CHC Website contains a large number of pages, most of which are unrelated to insurance. To generate a domain with more representative Web pages, Web pages that do not share the common domain name, but that are located a predetermined number of clicks away from the Web pages in the domain can be included. Meanwhile, the domain can be further refined to exclude Web pages with certain content characteristics, such as Web pages with the phrase “physician biographies.”

In a further embodiment, the domain can be predetermined. For example, agents at a call center associated with the CHC are available to answer calls related to the CHC Website, which is the predetermined domain. However, in yet a further embodiment, a predetermined domain can be modified by expanding or decreasing the domain as described above with respect to FIG. 3.

After defining the domain, information within the Web pages of the domain is identified and extracted. FIG. 4 is a block diagram showing, by way of example, processes 50 for obtaining information for use in generating an index. A Web crawler traverses (block 51) and parses (block 52) the Web pages in the defined domain. The Web pages within the domain can be identified and analyzed by traversing links within the Web pages or by traversing a list of the Web pages. To traverse by link, the html code of each Web page within the domain is parsed, and anchor tags and corresponding destination URIs are extracted (block 53). The Web crawler then visits (block 54) each URI via a depth-first or breadth-first search. Relevant information from the Web pages is then extracted (block 55). The relevant information can include from the Web pages, metadata, and structure, such as connections between the Web pages. Alternatively, to traverse the Web pages based on a list, URIs for each Web site can be complied into a list (block 56) and the list is then visited in order (block 57). Relevant information is extracted (block 58) from each of the visited Web pages.

The relevant information extracted from the Web pages of the designated domain is used to generate an index (block 59). The index can include a graph representation of the Web pages as nodes and connections between the Web pages as links, or a hash table, which maps each Web page to a set of attributes.

The index information can be used to generate a recommendation for navigation. FIG. 5 is a flow diagram showing, by way of example, different types of recommendations for navigation assistance. A recommendation can be generated using a recommender 61, such as a short link generator 62, a search term generator 63, or a path recommender 64. The short link generator 62 generates a shortened URI as a replacement for the original, longer URI assigned to the destination Web page. The shortened URI can be generated using an algorithmically-generated value, such as hash code, or based on a semantically meaningful short form.

The algorithmically-generated value can be a TinyURL, by Gilby Productions, which provides short aliases for redirection of original URIs based on the domain name tinyurl.com. However, TinyURLs are generally unrelated to the content of the desired Web page and fail to assist a user in accessing the same page at a later date.

Meanwhile, a semantically meaningful short form URI can be based on terms that are related to information provided on the Web page of interest. For example meaningulurl.com maps arbitrary URIs to short forms using predefined controlled domain names that are extended by user-selected text strings. If the meaningful short form URI is unique from any existing short form, the URI is created and reserved for a limited period of time and recycled upon expiration. To further personalize the shortened URIs, easy-to-remember words or phases that are shared between the user and the agent should be used. Also, to assist the users in learning how to access the Web page on their own, the shortened URIs should have structure and be related to the content of the Web page represented by the short link. Further characteristics for selecting the shortened URIs include using or abbreviating a domain of interest upper level name, an upper level interest name or Website structural information, the user name or related information, the agent name or related information, keywords or code relevant to the interaction between the user and the agent, date and time information, and any agreed upon words between the user and the agent. The shortened URIs can be determined automatically or by an agent. In one embodiment, the agent is provided with a list of the characteristics for use while selecting a shortened URI.

Once the shortened URI is selected, the Web page associated with the original URI is mapped to the shortened URI. Additionally, the shortened URI can be refined to include meaningful information by shortening or lengthening the shortened URI. If approved, the shortened URI is communicated to the user and a shortened URI service provider implements the associated mapping into a public Web structure. Different callers that are looking for the same Web page of interest can be provided with the same link or with a different link that can be characterized to that caller, such as “johnsinsuranceform.com” versus “mariasinsuranceform.com.” Also, effectiveness of the short link URI can be measured by how easy the link is to type into a Web browser, how memorable the link is to remember, and how relevant the link is to the Web page of interest, as well as other factors.

A recommendation for navigation can also be provided as a search query. For instance, a set of search terms can be determined for locating the Web page of interest as a top search result. The search terms are then provided to the caller who can enter the terms as a query and locate the page of interest. FIG. 6 is a flow diagram showing, by way of example, a process for generating a search query recommendation for navigation assistance. A set of search words is obtained (block 71) from one or more Web pages, such as the Web page of interest, all Web pages in the domain of interest, or a reference set of Web pages, that can be defined by crawling domain-related terms or compiling domain ontologies. Alternatively, the search terms can be stored and obtained from a previously generated index, such as a hash table, as well as other types of indices. The list of search terms can be optionally refined, such as by limiting the number of search terms for further processing or limiting the sections of the Web pages from which the search terms can be obtained. For example, the number of search terms can be reduced by removing stop words or stemming the words. Also, the number of search terms can be reduced by looking for terms that appear in one or more sections of the Web page, including the title, headers, and text of an html version of the Web pages.

Combinations of the search terms are identified (block 72) as possible search queries. In one embodiment, all possible search term combinations are identified. A number of the combinations can be reduced by limiting the number of search terms, as described above, or by setting a maximum number of words for inclusion in a search combination. In one embodiment, a maximum number of search terms for combining in a query is set to three terms. Once determined, those combinations that are unlikely to identify the Web page of interest are removed (block 73). Specifically, the search terms are each analyzed to determine a commonality of that term using term frequency-inverse document frequency (“tf-idf”). A high tf-idf score indicates that the term appears many times in a particular Web page and few times in other Web pages, which makes the term a good candidate for identifying that particular Web page. Combinations of search terms each having low tf-idfs can be removed to reduce the number of possible search queries to test.

In a further embodiment, two or more terms are analyzed for overlap. In one example, a first term is present in half of the Web pages in the domain, while a second term is present in a different half of the Web pages. Using tf-idf, each term would have a low tf-idf score. However, an overlap of the two words may only appear on the Web page of interest and thus, both terms are good even though the tf-idf score is low.

A search is performed using each of the remaining combinations of search terms (block 74) as search queries to identify one or more Web pages in the domain as search results for each of the queries. The search queries can be applied to the URI of each Web page in the domain or to the content of each Web page to identify results. The top N number of resulting Web pages is identified (block 75) and each Web page is mapped (block 76) to the best search query for that Web page, which is determined using the N number of results for each query.

Generally, each Web page in the domain should appear at least one in the search results. If a Web page is only identified as a top N result for a single search query, then that Web page is mapped to that search query. Alternatively, if a Web page is listed as a top N result for two or more search queries, the best search query for that Web page can be identified based on one or more selection factors, including how difficult are the words in the query, how many words does the query include, and how high is the Web page ranked in the top N search results for that query. For example, the search query with the easiest words, the least number of words, or that ranks the Web page the highest is the best search query. Additionally, the best query can be determined using a combination of the selection factors. Other selection factors are possible. Each Web page can be stored with the search query in a one-to-one mapping chart. Upon a request from a user to access a Web page, the search query can be obtained from the mapping and provided to the user. The search query can be obtained automatically after an agent enters the requested Web page or manually by the agent.

In one example, a caller requests instructions for locating information on ankle sprains on the CHC Website from an agent. The agent can request instructions for providing to the caller, such as by entering the requested information via a user interface. If the request has already been submitted, a previously generated query associated with the requested information is looked up in the mapping stored in a database and provided to the caller. In contrast, if the request has not been previously submitted, a recommendation for obtaining the requested information is generated and provided to the agent as a search query for relaying to the caller. Alternatively, the query can be automatically provided to the caller. Subsequently, the caller can enter the search query into a local search engine on a Web page or on a public search engine across the Internet to access the destination Web page with the desired information by selecting the result associated with the desired Web page.

A recommendation for navigating to a destination Web page can also be a path from a source Web page to the desired Web page. A navigation path allows the caller to locate the Web page of interest by clinking on links of Web pages. FIG. 7 is a flow diagram showing, by way of example, a process 80 for generating a path recommendation for navigation assistance. A source, or start, Web page is identified (block 81). For instance, a caller is looking for an insurance form on the CHC Web site. The home page of the CHC Web page can be designated as the source page. Next, a destination, or desired, Web page is identified (block 82). For example, the page on which the insurance form is located can be identified as the destination Web page. Subsequently, a path is determined (block 83) between the source and destination Web pages. The path can be generated automatically or by the agent, and is determined based on information provided in the index, which is further described above with reference to FIG. 4. The index can be a graph or map representation of the Website to which the Web page of interest belongs or a representation of the domain, which can be the same or different from the Website. In the map representation, each Web page can be represented as a node, while the connections between the Web pages are represented as links, such as lines. Based on the map representation, a path can be determined.

The determined path can be the shortest path, the most intuitive path, via a predetermined Web page, based on one or more efficiency metrics, or based on topics. The shortest path can be the path that includes the fewest number of links to reach to the Web page of interest. In one embodiment, the Dijkstra shortest path algorithm can be applied to the hyperlinks that connect the Web pages within the domain for the source and destination Web pages. Other algorithms are possible. Selection of a particular path can be based on characteristics of the caller or as a default. For instance, an older caller may want to get to the Web page of interest with the shortest amount of links so that he can later remember how to reaccess the Web page, whereas a more savvy user may desire the most intuitive path, even though the path is longer.

A recommended path can be routed via a predetermined page when the Web page is important, should be seen by the caller, or helps provide insight as to the rest of the Website. Other reasons for routing the path through the predetermined pages are possible. Returning to the above example, the caller requests instructions to obtain an insurance form on the CHC Website. The home page of the CHC Website can be designated as the source page, while the Web page with the insurance form can be designated as the destination Web page. A path can be generated from the home page to the insurance page through the contact page, which includes the address and fax number to which the completed insurance form can be sent. When the navigation instructions for the recommended path are provided, the caller sees the contact information and will later be able to navigate back to obtain the contact information after he has filled out the insurance form.

During path generation, a set of metrics can be considered for identifying an efficient, clear and easy to understand path for providing to the caller. The metrics can include a number of hops, link visibility, link length, locating links, site exposure, and scrolling. A number of hops identifies how many Web pages a caller passes en route to the destination page. Link visibility focuses on how quickly and clearly the agent can describe attributes of a hyperlink (link) to the caller, which links to another Web page in the path. For example, links can be text, images, buttons, or other graphics. In one embodiment, depending on the links, describing an image to the user for identifying a link may be easier than describing text, or vice versa. Link position, size, color, or content can be used as the attributes for describing a link. Link length provides a measure of length of a link. For example, longer links can be more confusing for a caller. Link location identifies an ease with which the caller identifies a link on the Web page. Factors for determining ease of the caller's identification includes color, size, and location of the link on a screen. For instance, the link may only be visible if the user performs an action, such as hovering over a tab on a Web page, which can be difficult for the caller to locate. Site exposure includes identifying how much Website structure does the caller see and learn and how likely is the caller to locate a similar page on his own. Scrolling identifies whether the caller must scroll down a Web page to find a link for clicking to get to the next Web page on the recommended path.

In one example, a Web page of a possible path may require the user to scroll down to identify a link. Thus, the path may include a detour so that the Web page is not included since the link can be difficult for the caller to identify. In a further example, Web pages that include bigger or more visible links can be included in the path since the links are easy for the caller to find.

The metrics can be applied to determine a path with respect to the metric selected. In one embodiment, one of the metrics is selected and optimized over a graph of the Website or domain using Dijkstra's algorithm. In a further embodiment, a least-cost algorithm that can handle multi-dimensional weights can be used to optimize over more than one metric, such as the Self-Adapting Multiple Constraints Routing Algorithm.

Paths can also be generated based on topics. For instance, the caller is looking for an insurance form. A path can be generated that takes the caller through all Web pages that are relevant to insurance, such as a frequently asked questions page on insurance, contact information for sending insurance forms, and how get an update on insurance claims. The pages can be identified using the map representation. Specifically, each node in the map representation is associated with metadata, such as topics, content, and relationships, as well as other metadata. In a further example, a caller may be interested in obtaining information about diabetes on the CHC Website, which has different paths from the home page to information on diabetes Type 1and diabetes Type 2. Since Type 1 and Type 2 diabetes are related, the respective paths generated for each type can route the caller through a general diabetes page or another common page. Routing the paths through a common page may include more links, but can be easier for the caller to remember, as well as provide the caller with additional related information. Other examples are provided.

Once the recommendation is generated, the instructions of the recommendation are relayed to the caller. The instructions can be provided verbally by the agent in a step-to-step manner, as text, or via an automated response system. However, other methods for providing the instructions to the caller are possible. Relaying the instructions to the caller via a script is further discussed below. The recommended path can then be evaluated for efficiency. If the path is not efficient, the path can be revised or a new path can be generated. Additionally, multiple paths can be generated and ranked to determine the best path.

Past data and common behaviors can be used to improve path generation. The most common starting points and desired destination Web pages are identified to provide insight as to a general flow of a Website. Based on the common starting and endpoints, paths that share large subsections can be generated. For example, a path from page A to page B can share many of the same hops as a path from page C to page B. Hierarchical grouping can be used to see which group results in the most shared hops. Map representation and path generation can also be useful for redesigning or restructuring the Website having the Web page of interest. Analyzing actions of users with respect to the pages and grouping similar flows into the same path can help web designers understand how best to group content together on Web pages. As well, the approach could be used to reduce the number of links along a path and aggregate all related information onto a single page.

The recommendations, whether provided as a short link, search query, or path, can each be provided to a caller via a script. Scripts are a convenient way to provide consistent instructions to the callers by different agents. The script is generated as a string of text that can be read by the agent who directs the caller to the desired information. The script can be based on the recommendation for navigation instructions, along with explanatory or narrative elements to express the navigation in human readable form. For example, a script can be generated automatically based on the recommended navigation instructions or manually by a person affiliated with the call center in which the script will be used. In a further embodiment, the script is prerecorded and played to the caller, or sent to the caller as text.

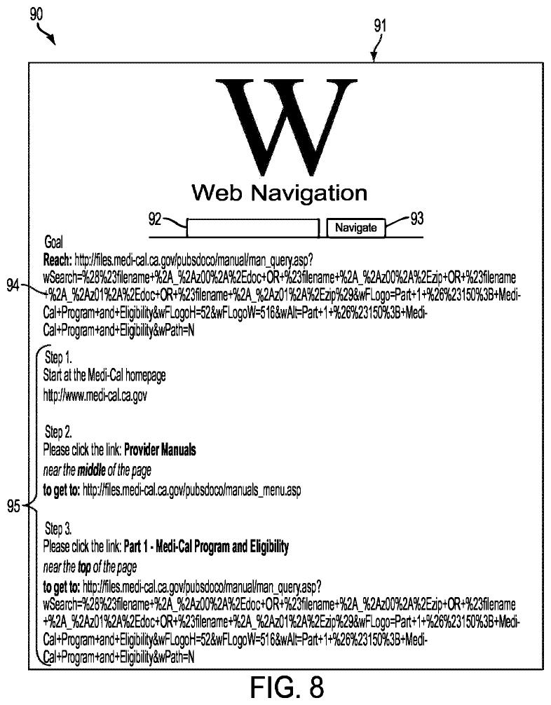

Once generated, content of the script is relayed to the caller. FIG. 8 is a screenshot 90 of a Web page 91 displaying a script to an agent. The Web page 91 can be displayed to an agent at a call center and includes a navigation box 92, goal 93, and script 94. Other fields on the Web page 91 are possible, including a map representation of the domain, user data and preferences, and a navigation recommendation selection field. The agent can enter a request for a Web page of interest from a caller in the navigation box 92. Subsequently, the agent can select a navigation button 93 located proximate to the navigation box 92 to request navigation instructions to the entered Web page of interest. Once the request is processed and navigation instructions are determined, a script is displayed. The script can be newly generated based on the request or can be previously generated and stored in a database for accessing by the agent. The script can include a goal 94, which is the Web page of interest, and steps 95 explaining how to navigate to the Web page of interest. The agent can then relay the instructions to the caller step-by-step using the script.

The script can be stored in a database and used to document a portion of the call. Specifically, transformation rules can be applied to the script for conversion into a format suitable for archiving, such as by recording the scripts, applying text filters, or other language processing techniques. For example, after every step of the navigation instructions, actions and speech can be automatically documented for the agent based on the script. Additionally, at each step, the agent can manually document actions or speech of the caller. In one embodiment, the record is generated by appending each step as provided in the script to the record and providing a cursor after the step so the agent can start to type at the appropriate location. The record is then generated step-by-step as the agent relays the instructions to the caller.

In a further embodiment, the recommendations can be evaluated for effectiveness. The measures of effectiveness can include repeatability, learnability, error rate, time to convey instructions, number of clicks, number of keystrokes, and similar pages. Repeatability measures how easily a user is able to get to the same Web page of interest without the assistance of an agent, such as by testing sets of navigations over a sample population of test participants and by keeping a history of scripts and repeated calls by the caller or difficulties reported by the agent. Learnability measures how much the caller learns about the structure of the Website that includes the Web page of interest. Error rate identifies a percentage of time that the recommendation results in an error, such as by providing instructions to the wrong Web page, and how likely errors are made in communicating the recommendation. The time to convey instructions measures a length of time needed for the caller to go from the source page to the destination page. The number of clicks measures how many clicks, such as mouse clicks or finger taps, are required based on the instructions directing the caller from the source page to the destination Web page. The number of keystrokes measures how many keystrokes are required based on the instructions directing the caller from the source page to the destination Web page. Similar pages measures how easily a caller can get to a similar page after being instructed to the page of interest, which can be determined by testing sets of navigations over a sample population of test participants.

The calls can be monitored based on the measures to determine whether the recommended navigation instructions should be revised. If the measures show that the recommendation is not effective based on the measures, such as locating the Web page of interest or teaching the user how to locate the Web page on their own, the recommendation can be revised. For example, a different short link URI, search query, or path can be generated and stored for further use.

In a further embodiment, the user can bypass the call center and directly contact the server via a Web-enabled device, such as a cellular telephone or computer for navigations instructions, which are then displayed on the Web-enabled device.

In yet a further embodiment, pages different from the Web page of interest can be recommended to the caller. Analyzing sets of pages that one or more callers visit in a single session provides an indication that the pages are related to a common task, such as locating the Web page of interest. If a lot of people visit the same sets of Web pages in a session, the pages are likely related. Thus, if a caller visits a page, which is part of a related set of pages, a recommendation for the caller to visit the other related pages can be made.

While the invention has been particularly shown and described as referenced to the embodiments thereof, those skilled in the art will understand that the foregoing and other changes in form and detail may be made therein without departing from the spirit and scope of the invention.

What is claimed is:

1. A system for providing Website navigation instructions, comprising:
a server comprising a central processing unit, memory, an input port, and an output port, wherein the central processing unit is configured to:
receive a request for directions from a source Web page to a destination Web page received from a user;
identify a Web page of interest as the destination Web page;
generate a domain of Web pages related to the destination Web page, comprising:
identify Web pages that are related to the destination Web page; and
perform at least one of selecting those of the identified Web pages that satisfy one or more exclusion rules and refining the identified Web pages as the domain of Web pages;
extract information from each Web page in the domain;
generate an index of the extracted information from the domain of Web pages for the destination Web page, generating the index including structuring the index as an index type between one of a graph representation and a hash table, wherein the index type is structured based on a type of recommendation to be generated;
distinguish whether the index associated with the destination Web page is the graph representation or the hash table;
select navigation directions comprising links or search terms to the destination Web page based on whether the index associated with the destination web page is the graph representation or the hash table; and
provide the selected instruction to the user in response to the request based on the index type associated with the destination web page, comprising:
provide a path instruction comprising two or more links to Web pages located between the source Web page and the destination Web page as the selected instruction to the user when the index type of the destination web page is the graph representation; or
provide a query instruction comprising two or more search terms as the selected instruction to the user when the index type of the destination web page is the hash table.

2. A system according to claim 1, wherein the central processing unit assigns a short link to the destination Web page based on the extracted information and provides the short link to a user as the instruction.

3. A system according to claim 1, wherein the central processing unit determines a search query to identify the Web page of interest and provides the search query to a user as the query instruction.

4. A system according to claim 3, wherein the central processing unit generates the search query by selecting a set of search words from the domain of Web pages, by identifying combinations of the search terms, by filtering out the combinations of search terms that are unlikely to identify the destination Web page, by applying the non-filtered combinations as possible search queries, by identifying one or more Web pages as results, and by mapping each of the results to one of the search queries.

5. A system according to claim 1, further comprising:
a source Web page; and
a path determined between the source and destination Web pages, wherein the path is provided to a user as the path instruction.

6. A system according to claim 1, wherein the path is generated based on at least one of a predetermined Web page through which the path is directed, structures within the Web pages, and shortest path.

7. A system according to claim 1, further comprising at least one of:
a script generated based on the instructions;
a display to provide the script to an agent during a call with a caller; and
a record of the call based on the script.

8. A system according to claim 1, wherein the central processing unit measures effectiveness of the instruction by measuring metrics of the instruction, wherein the metrics comprise at least one of repeatability, error rate and learnability and by analyzing the metrics.

9. A system according to claim 1, wherein the central processing unit determines the domain by identifying a collection of Web pages with a common domain related to the destination Web page.

10. A system according to claim 9, wherein the central processing unit performs at least one of excludes particular pages within the domain based on a Web page title, expands the domain by including additional Web pages, and decreases the domain by excluding pages based on content characteristics.

11. A method for providing Website navigation instructions, comprising:
receiving from a user, a request for directions from a source Web page to a destination Web page;
identifying a Web page of interest as the destination Web page;
defining a domain of Web pages, comprising:
identifying Web pages that are related to the destination Web page; and
performing at least one of selecting those of the identified Web pages that satisfy one or more exclusion rules and refining the identified Web pages as the domain of Web pages;
extracting information from each Web page in the domain;
generating an index of the extracted information from the domain of Web pages for the destination Web page, generating the index including structuring the index as an index type between one of a graph representation and a hash table, wherein the index type is structured based on a type of recommendation to be generated;
distinguishing whether the index associated with the destination Web page is the graph representation or the hash table;
selecting navigation directions comprising links or search terms to the destination Web page based on whether the identified index type associated with the destination web page is the graph representation or the hash table; and
providing the selected instruction to the user in response to the request based on the index type associated with the destination web page, comprising:
providing a path instruction comprising two or more links to Web pages located between the source Web page and the destination Web page as the selected instruction to the user when the index type of the destination web page is the graph representation; or
providing a query instruction comprising two or more search term as the selected instruction to the user when the index type of the destination web page is the hash table.

12. A method according to claim 11, further comprising:
assigning a short link to the destination Web page based on the extracted information; and
providing the short link to a user as the instruction.

13. A method according to claim 11, further comprising:
determining a search query to identify the Web page of interest; and
providing the search query to a user as the query instruction.

14. A method according to claim 13, further comprising:
generating the search query, comprising:
obtaining a set of search words from the domain of Web pages;
identifying combinations of the search terms;
filtering out the combinations of search terms that are unlikely to identify the destination Web page;
applying the non-filtered combinations as possible search queries;
identifying one or more Web pages as results; and
mapping each of the results to one of the search queries.

15. A method according to claim 11, further comprising:
identifying a source Web page;
determining a path between the source and destination Web pages; and
providing the path to a user as the path instruction.

16. A method according to claim 11, wherein the path is generated based on at least one of a predetermined Web page through which the path is directed, structures within the Web pages, and shortest path.

17. A method according to claim 11, further comprising at least one of:
generating a script based on the instructions;
providing the script to an agent during a call with a caller; and
generating a record of the call based on the script.

18. A method according to claim 11, further comprising:
measuring effectiveness of the instruction, comprising:
measuring metrics of the instruction, wherein the metrics comprise at least one of repeatability, error rate, and learnability; and
analyzing the metrics.

19. A method according to claim 11, further comprising:
determining the domain by identifying a collection of Web pages with a common domain related to the destination Web page.

20. A method according to claim 19, further comprising at least one of:
excluding particular pages within the domain based on a Web page title;
expanding the domain by including additional Web pages; and
decreasing the domain by excluding pages based on content characteristics.
